(19) United States
(12) Patent Application Publication
(10) Pub. No.: US 2017/0116675 A1
(43) Pub. Date: Apr. 27, 2017

(54) GENERATING TERM INSURANCE SERVICE MODEL IN SOFTWARE DEFINED ENVIRONMENTS

(71) Applicant: International Business Machines Corporation, Armonk, NY (US)

(72) Inventors: Sasikanth Eda, Vijayawada (IN); Deepak R. Ghuge, Ahmednagar (IN); Varun Mittal, Punjab (IN); Sandeep R. Patil, Pune (IN); Gandhi Sivakumar, Victoria (AU)

(21) Appl. No.: 14/923,816

(22) Filed: Oct. 27, 2015

(51) Int. Cl. G06Q 40/08

(52) U.S. Cl. CPC G06Q 40/08

(57) ABSTRACT

A method is provided to use a weighted model for determining a term insurance premium based on each operation performed by a user in a software defined infrastructure. For each operation performed by the user, the operation is classified and weighted against its results, and risk associated with the results is analyzed. A term insurance amount is calculated based on the risk for recovery, and expertise of IT resource vendor. An end user is equipped with flexibility of enabling insurance for a particular software operation.

### BACKGROUND

The present invention relates generally to the field of information technology resource service, and more particularly to term insurance premium in software defined environments.

A software defined environment (SDE) optimizes the entire computing infrastructure (e.g., compute, storage and network resources) so that it can adapt to the type of work required. In a SDE, information technology (IT) resources are dynamically assigned based on application characteristics, best-available resources, and service level policies to deliver continuous, dynamic optimization and reconfiguration to address infrastructure issues. Underlying all of this are policy-based compliance checks and updates, in a centrally managed environment.

Term insurance or term assurance is an insurance model which provides coverage at a fixed rate of payments for a limited period of time. After that period expires, coverage at the previous rate of premiums is no longer guaranteed and the client must either forgo coverage or potentially obtain further coverage with different payments or conditions. Term insurance model is the least expensive way to purchase a coverage amount per premium basis over a specific period of time.

### SUMMARY

In one aspect of the present invention, a method, a computer program product, and a system includes: receiving an operation and an insurance option associated with the operation from a user; collecting environment details associated with the operation; transmitting the operation, the insurance option, and the environment details to a server; analyzing the operation on the server using the environment details to determine risks associated with the operation; estimating development costs based on the determined risks; determining the term insurance based on the development costs and the insurance option; transmitting the term insurance to the user; registering a term insurance premium responsive to the user acceptance of the determined term insurance; and billing the term insurance premium to the user; wherein: at least the step of collecting environment details is performed by computer software running on computer hardware.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system; and

FIG. 4 is a term insurance shell for a software defined environment according to one embodiment of the present invention.

### DETAILED DESCRIPTION

Some embodiments of the present invention provide a software framework and an algorithm that facilitate a term/temporary insurance service model in software defined environments (SDEs). The framework is a software infrastructure which includes an algorithm tied to a call home, changes in command line interface (CLI) framework to collect insurance enablement from an end user, a model which predicts the risk associated with every operation the user performs, and determination of insurance premium dependent on the risk calculated. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions, or acts, or carry out combinations of special purpose hardware and computer instructions.

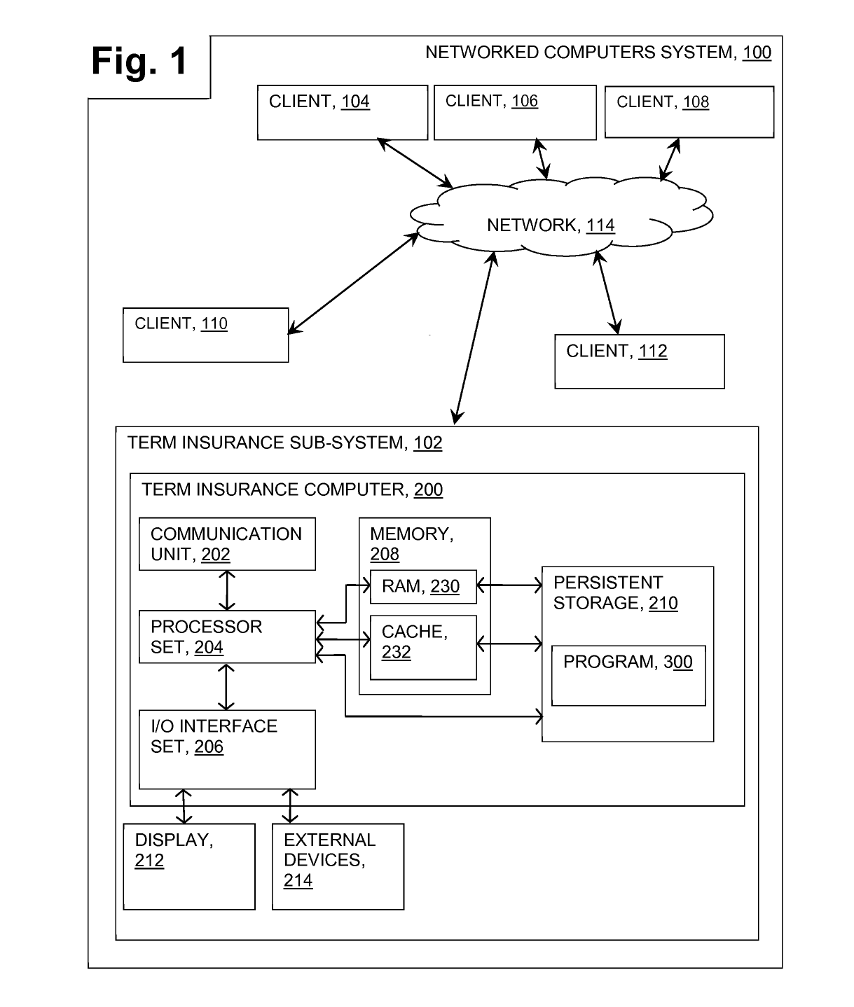

The present invention will now be described in detail with reference to the figures. FIG. 1 is a functional block diagram illustrating various portions of networked computers system 100, in accordance with one embodiment of the present invention, including: term insurance sub-system 102; _clients 104, 106, 108, 110, 112; communication network 114; term insurance computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202). I/O interface set 206 allows for input and output of data with other devices that may be connected locally in data communication with computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Program 300 operates to provide a software framework and an algorithm that facilitate a term insurance service model for every operation/action a user intends to perform in a software defined environment (SDE). Specifically, program 300 builds a virtual model of software infrastructure at a central server, applies multiple tuning, scenarios, and hacks to the software infrastructure, and analyzes risk associated with the operations by classifying and weighting user action/operation against each corresponding SDE environment. Based on the results of the operation simulated in the virtual model the algorithm determines the amount of insurance premium. Once the user agrees on the calculated insurance amount, required safety measurements and backup measures are taken place.

Some embodiments of the present invention recognize the following facts, potential problems and/or potential areas for improvement with respect to the current state of the art: (i) in a traditional software warranty model, a user will be charged separately if the software contract is violated during a predefined contract period (e.g., the administrator uses tasks other than admin shell or uses in unsupported configurations); (ii) in the traditional software contract model, the client assume that the deployed appliance is already tuned for the workload and necessary education has been provided to the administrators; (iii) in a software defined environment (SDE), the administrator would require help or wants to take advice in case of risky operations; and/or (iv) in a SDE, the software vendor has no idea/control on the client environment (it may involve multiple configuration changes, tweaks, hacks, breaks etc.) or even workloads get changed frequently.

The conventional software contract model more or less works as described below. For example, the hardware shipment will be defect free and for any defects or malfunction occurred during the initial 100 hours of test (time for system under test) the hardware will be replaced. Once the hardware is operational, within one year it would be under warranty and after that customers or users need to pay for its servicing. With regard to software, the provided software will work with the shipped hardware with no bugs, and if any bug is identified, will be fixed according to the agreed service level agreement (e.g., service-1 within one week, service-2 within a month, and so on). Further, if the software contract cycle is reduced from five years to three years, then a customer or user pays a certain amount of money for the first three years period, and after the first three year period the customer or user has to pay the same amount of money or more for continuing the service contract. During the period of service contract, if the software contract is violated, for example if the administrator uses tasks other than admin shell (e.g., run as root or any other hacks) or uses in unsupported configurations, the administrator or customer will be charged for the violation service separately.

However, problems with a conventional software contract model occur. For example, the customer assumes that the deployed appliance is already tuned for the workload and necessary education has been provided to the administrators. In this case it is hard for the software vendors to convince the customer to pay a certain amount of money for three years software support. As another example, network attached storage (NAS) system is like an appliance (e.g., hardware appliance or software appliance) and is tuned to environments (e.g., workload) at the first time setup by the vendor. The administrator or user of the NAS system is least bothered to change its settings, which means the NAS system is in an ideal condition and the user feel they won't require software warranty.

Further, from the point of view of the customer, the NAS administrators are highly paid and have the required skill to debug and fix the software issues. In this scenario the customer would be under the impression that software warranty is not required and is just wastage of investment.

However, in software defined environments (SDEs), the software vendor has no idea or control on the client or user environment (e.g., it may involve multiple configuration changes, tweaks, hacks, breaks, etc.). Further the workloads may get changed frequently, and rapidly. For example, in a SDE, a NAS system may be used for testing application for day one; used for customer demo purpose for day two; used for hadoop workload for day three, and used for department logistic data for day four. In such scenarios, the administrator would require help or wants to take advice in case of risky operations. Beside the limited warranty associated with the software (such as bug fixes, security patches, etc.), for every user operation the software vendors should have the capability to assess each operation and its need for a term insurance and help the user accordingly.

In some embodiments of the present invention, a framework and algorithm are provided to facilitate a term insurance service model for every operation or action the administrator or user intends to perform in a software defined environment. The framework uses a weighted model suited for a software defined infrastructure (where the software vendor is unknown of plenty of scenarios including hacks and tuning used). For each operation performed by the user, the operation are classified and weighted against its results. And risk of the results is analyzed, based on which an insurance amount is calculated for recovery and expertise of the software vendor.

Specifically, the framework is tied to a call home functionality and the end user or customer is equipped with a flexibility of enabling a term insurance option for a particular software operation. Once the user enables the insurance option, the operation along with environment details are transferred to a central server via the call home. At the central server, a virtual model is built using the exact hacks, tuning applied on the production systems (hardware and software) and the same user operation is performed. Based on the results of the operation, the amount of insurance premium is determined for the operation. Once the user agrees on the calculated insurance amount, required safety measurements and backup measures are performed. This kind of insurance framework in software defined environments benefits small and medium customers from signing a predefined service contract and can have a dynamic insurance plan based on the operation in which the user is not confident enough.

The call home herein is a feature present in enterprise or consumer products, which enables an automated phone call, message (e.g., short message service messages, and Email) to the vendor from and by the product itself when appropriate triggers are enabled in the products. For example, the administrator can enable this feature to contact a vendor help desk, if the machine gets failed; or the vendor can configure this feature to send logs in case of failures.

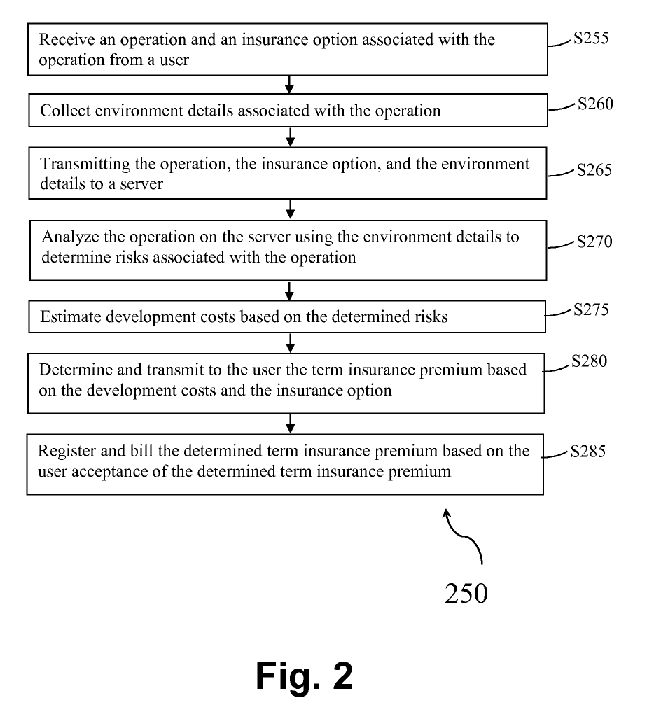

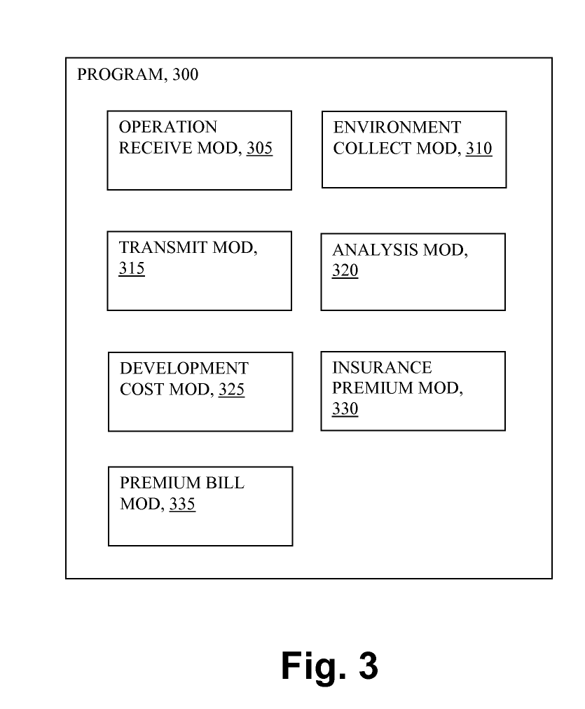

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where operation receive module (“mod”) 305 receives an operation and an insurance option associated with the operation from a user. In this example, an administrator or user performs certain tweaks suited to his or her environment using, for example, some Linux commands in root shell, or makes some changes in the software code such that the software sustains the changing workloads, or even more risky operations such as authentication changes, each of which herein is referred to as an operation by the user.

In this example, in order to obtain a term insurance for a particular operation, the user uses a special insurance option associated with each CLI (for example, Linux commands, commands specific to the software in admin shell). Alternatively, the user may use an insurance shell to apply insurance for a series of commands usage (i.e., operation). Herein the CLI is a command line interface that is a script or a command provided to the user for performing administrative operations. In this example, the Linux shell, admin shell, and/or the insurance shell may be performed on any computer, such as, clients 104, 106, 108, 110, 112 in FIG. 1.

An example CLI in Linux shell or admin shell is shown as:
[Admin]#CLI—option1 <value1>—option2 <value2>[—insurance “1”];
   where “CLI” stands for the actual command (e.g., if the user wants to list all files in a directory, the CLI would be “1s” in Linux), “—option1” stands for command line input (e.g., for the “1s” command, the user also wants to list hidden files, then the “—option1” will be “-a”), and <value1> is the value passed to the “option 1” (it may be mandatory or optional). The explanations of “—option2” and <value2> are the same. In the above example “[—insurance “1”] “stands as an optional parameter that can be used with any CLI, which is used for the user to selectively enable an insurance option for a particular command when the user is using admin shell.

An example of CLI in insurance shell is shown as:
[Insurance/1]$ CLI—option1 <value1>—option2 <value2>;
   where the explanations of “CLI”, “—option 1”, “<value 1>”, “—option 2”, and “<value>” are the same as in the example CLI in admin shell above. In addition, “[Insurance/1]” stands for insurance shell where all commands executed in this interface will have insurance option set by default (“/1” stands for an insurance value “1”).

Herein, “admin shell” (may also be referred to as “restricted shell”) is a typical interface provided to an administrator or user (apart from Graphical User Interface), where this interface executes commands only specific to the particular or host machine (administrative commands listed by the vendor) and disables all kinds of other operating system commands which are not developed or internal to the machine.

In this example, the value assigned to the insurance option, can be varied. Table 1 shows some values for the insurance option and their corresponding interpretations.

TABLE 1
Values assigned to the insurance option
and their corresponding interpretation.

| Insurance value | Interpretation |
|---|---|
| 0 | No Risk Insurance |
| 1 | Risk insurance (Economy/Default price) |
| 2 | Risk insurance (Privileged) |
| 3 | Risk insurance (High importance) |
| N | Risk insurance (where the vendor determines the |
| | appropriate insurance amount after analyzing the |
| | risk of command triggered) |

Processing proceeds to step S260, where environment collect module 310 collects environment details associated with the operation. In this example, once the user uses the insurance option and triggers the operation, the call home feature (as mentioned earlier, it is a component available in almost all enterprise products—which forms communication link with the user software and the vendor support system) records the operation and the insurance option, collects the required environment details. Herein, the environment details vary based on the appliance. For example, for a storage appliance the environment details correspond to number of file systems, number of File sets, health of cluster, protocol status, authentication status, hardware, controller status, storage configuration, and so on; whereas for an appliance corresponding to analytics, the environment details may include hypervisor health, storage report, virtual machines status, hardware details, etc.

Processing proceeds to step S265, where transmit module 315 transmits the operation, the insurance option, and the environment details to a central server. In this example, the operation, the insurance option, and the environment details recorded and collected by the call home are passed to a central server (e.g., insurance premium computer 200 in FIG. 1) where a knowledgebase program (configured at the vendor support site) is applied.

Processing proceeds to step S270, where analysis module 320 analyzes the operation on the server using the environment details to determine risks associated with the operation. In this example, at the central server, a weighted virtual model is built using the exact hacks and tuning applied on the production systems and the same user operation is performed. The weighted virtual model simulates the user scenario/operation using the same collected environment details, and provides the results of the user provided CLI operation. That is, the weighted virtual model involves a creation of virtual appliance replicating the environment details and/or configurations collected and transmitted by the call home, and identifies the risks or impact generated by the user provided CLI operations.

Herein the “hacks” include, but not limited to, unsupported, undocumented, untested configurations, unexposed operating system internal commands execution, untested installation type, unqualified third party integration, changing or tampering vendor code to suit their environments.

Table 2 shows an example of knowledgebase program (intended for NAS appliance as an example):

TABLE 2
An example of knowledgebase program.

| | | Within Standard | Premium |
|---|---|---|---|
| Task Classification | End Effects | Warranty? | Amount |
| Running as root | Complete/ | No | $100 |
| | partial | | |
| | destruction | | |
| Running software | Partial Outage | No | $10 |
| CLI and making | | | |
| unsupported | | | |
| configuration | | | |
| Running internal File | Full Outage | No | $70 |
| system commands | | | |
| Changing Authentication | Partial Outage | Yes | N/A |
| Migrating from std. | Full Outage | No | $90 |
| hardware to custom | | | |
| hardware | | | |
| Using workloads other | Partial Outage | No | $40 |
| than the quoted/un- | | | |
| tested/unsupported | | | |
| workloads | | | |

In Table 2, the column titled “Task Classification” includes a list of operations that a user may input as CLI; the column titled “End Effects” indicates the risks raised from the corresponding operation; the column titled “Within Standard Warranty” specifies whether the risks and the corresponding operation are covered by a pre-defined limited insurance contract (will be discussed later); and the column titled “Premium Amount” shows how much an term insurance premium will be charged for the operation by the vendor if the operation is not covered by the pre-defined limited insurance contract (will be discussed later). For example, if a user run the CLI as root, the risks associated with this operation will include complete or partial destruction of the user production system (including hardware and software).

Processing proceeds to step S275, where development cost module 325 estimates development costs based on the determined risks. In this example, based on the estimated risks, development or support functions cost is determined in order to fix the problems raised by this operation. Further, it will be determined whether the operation and the associated risks are covered by the pre-defined service contract, as shown in the column titled “Fall under std. warranty” in Table 2.

Processing proceeds to step S280, where insurance premium module 330 determines and transmits to the user the term insurance premium based on the development costs and the insurance option. In this example, based on the development cost estimation, a term insurance premium amount and/or type is determined for the operation. If the estimated development cost is greater which results in a higher premium amount than the insurance value provided by the user through the insurance option in admin shell or insurance shell, a confirmation to the user is transmitted to quote for a higher insurance premium/type. Similarly if the estimated development cost is lower which results in a lower premium amount than the insurance value provided by the user through the insurance option in admin shell or insurance shell, a confirmation to the user is transmitted to quote for a lower insurance premium/type. Alternatively, it is acceptable if the user prefers to continue with the higher premium (i.e., the insurance value provided by the user) than the quoted lower insurance premium. The term insurance quote is also based on a standard insurance premium for each corresponding operation as shown in the column titled “premium amount” in Table 2, which may be pre-defined by the vendor.

Processing proceeds to end at step S285, where premium bill module 335 registers and bills the determined term insurance premium based on the user acceptance of the determined term insurance premium. In this example, if the user accepts the quoted term insurance premium for the operation, a confirmation to the user is returned to confirm the invoice for the quoted term insurance, and the quoted premium amount is charged to the user. That is, based on the mutual agreement on the quoted premium amount/type, the quoted premium is registered and billed to the user for the operation that the user intends to perform.

In some embodiments of the present invention, if the user operation fails or damages the software or the system, a request is passed to the development or support team for recovery or fixing the issues; if the operation has passed successfully the operation will be passed to the development or support team for further analysis. Further, if the development or support team foresees any problem in future based on the analysis, comments from the development or support team will be passed to the user or administrator.

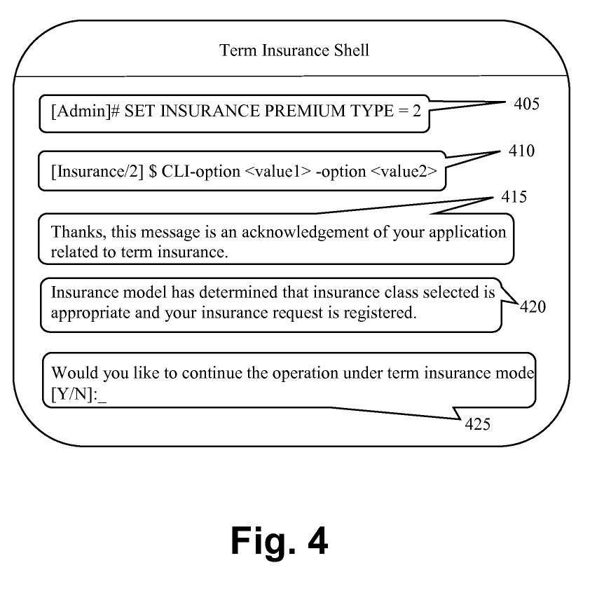

In some embodiments of the present invention, a second method may be carried out through a term insurance shell for software defined environment, as shown in FIG. 4. In 405, the administrator or the user provides an option for the insurance premium type for which the user intends to perform an operation. The user inputs the corresponding operation for the selected insurance premium type in 410. The insurance type and the corresponding operation are sent to a central server where the actual term insurance premium for the corresponding operation is determined, and a message as shown in 415 is returned. After determination of the actual term insurance premium, the central server notifies and confirm to the user regarding the actual term insurance premium. In this example, the insurance premium provided by the user is the actual insurance premium determined by the server, as shown in 420. Based on whether or not the user agrees to the determined insurance premium, the user will be asked whether or not he/she would like to continue the operation, as shown in 425.

Some embodiments of the present invention may include one, or more, of the following features, characteristics and/or advantages: (i) equipping an end user to enable insurance per software and/or hardware operation; (ii) identifying a risk scenario change based on a particular action; (iii) generating weighted model for weighing risk against a user operation; (iv) for every user operation the software vendor has the capability to assess each operation and its need for insurance. and/or (v) providing an insurance framework in software defined environment that benefits small and medium customers from signing a predefined service contract and can have a dynamic insurance plan based on the operation in which the customers administrator is not confident enough

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

User: includes, but is not necessarily limited to, the following: (i) a single individual human; (ii) an artificial intelligence entity with sufficient intelligence to act as a user or subscriber; and/or (iii) a group of related users or subscribers.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method comprising:
determining an operation, an insurance option corresponding to the operation, and a set of environment details;
analyzing the operation based, at least in part, on the set of environment details to determine a set of risks associated with the operation;
estimating a development cost based, at least in part, on the set of risks;
determining a term insurance premium based, at least in part, on the development cost and the insurance option; and
registering the term insurance premium responsive to an acceptance of the term insurance premium;
wherein:
at least the step of analyzing the operation is performed by computer software running on computer hardware.

2. The method of claim 1, further comprising:
responsive to the operation failing to complete, determining a solution corresponding to damage and/or failure of a corresponding system, the corresponding system including hardware and/or software.

3. The method of claim 1, further comprising:
responsive to a successful completion of the operation, analyzing the operation.

4. The method of claim 1, wherein determining the operation, the insurance option corresponding to the operation, and the set of environment details includes:
receiving the operation and the insurance option according to a user selection.

5. The method of claim 1, wherein the operation is a member of the group consisting of:
a command in a root shell;
a change in a set of software code; and
an authentication change.

6. The method of claim 1, wherein the set of environment details includes at least one of a protocol status, an authentication status, a storage configuration, a storage report, or a virtual machine status.

7. The method of claim 1, wherein the step of estimating a development cost based on the determined risks includes:
comparing the term insurance premium with a standard insurance premium for the operation as pre-defined by a vendor.

8. A computer program product comprising a computer readable storage medium having a set of instructions stored therein which, when executed by a processor, causes the processor to generate a term insurance for an operation in a software defined environment by:
determining an operation, an insurance option corresponding to the operation, and a set of environment details;
analyzing the operation based, at least in part, on the set of environment details to determine a set of risks associated with the operation;
estimating a development cost based, at least in part, on the set of risks;
determining a term insurance premium based, at least in part, on the development cost and the insurance option; and
registering the term insurance premium responsive to an acceptance of the term insurance premium;
wherein:
at least the step of analyzing the operation is performed by computer software running on computer hardware.

9. The computer program product of claim 8, further comprising:
responsive to the operation failing to complete, determining a solution corresponding to damages and/or failure of a corresponding system, the corresponding system including hardware and/or software.

10. The computer program product of claim 8, further comprising:
responsive to a successful completion of the operation, analyzing the operation.

11. The computer program product of claim 8, wherein determining the operation, the insurance option corresponding to the operation, and the set of environment details includes:
receiving the operation and the insurance option according to a user selection.

12. The computer program product of claim 8, wherein the operation is a member of the group consisting of:
a command in a root shell;
a change in a set of software code; and
an authentication change.

13. The computer program product of claim 8, wherein the set of environment details includes at least one of a protocol status, an authentication status, a storage configuration, a storage report, or a virtual machine status.

14. The computer program product of claim 8, wherein the step of estimating development costs based on the determined risks includes:
comparing the term insurance premium with a standard insurance premium for the operation as pre-defined by a vendor.

15. A computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to generate a term insurance for an operation in a software defined environment by:
determining an operation, an insurance option corresponding to the operation, and a set of environment details;
analyzing the operation based, at least in part, on the set of environment details to determine a set of risks associated with the operation;
estimating a development cost based, at least in part, on the set of risks;
determining a term insurance premium based, at least in part, on the development cost and the insurance option; and
registering the term insurance premium responsive to and acceptance of the term insurance premium.

16. The computer system of claim 15, further comprising:
responsive to the operation failing to complete, determining a solution corresponding to damages and/or failure of a corresponding system, the corresponding system including hardware and/or software.

17. The computer system of claim 15, further comprising:
responsive to a successful completion of the operation, analyzing the operation.

18. The computer system product of claim 15, wherein determining the operation, the insurance option corresponding to the operation, and the set of environment details includes:
receiving the operation and the insurance option according to a user selection.

19. The computer system of claim 15, wherein the operation is a member of the group consisting of:
a command in a root shell;
a change in a set of software code; and
an authentication change.

20. The computer system of claim 15, wherein the set of environment details includes at least one of a protocol status, an authentication status, a storage configuration, a storage report, or a virtual machine status.
